(19) United States
(12) Patent Application Publication
(10) Pub. No.: US 2026/0277215 A1
(43) Pub. Date: Sep. 17, 2026

(54) Method and System for Autonomous Inventory Monitoring and Control

(71) Applicant: Corvus Robotics, Inc., Mountain View, CA (US)

(72) Inventors: Mohammed Hanif Kabir, Mountain View, CA (US); Jonathan James Sandau, San Jose, CA (US); Yue Wu, Mountain View, CA (US)

(21) Appl. No.: 19/077,766

(22) Filed: Mar. 12, 2025

(51) Int. Cl. G05D 1/246; G05D 1/667; G05D 101/15; G05D 105/28; G05D 107/70; G05D 109/10; G05D 109/20; G06Q 10/087

(52) U.S. Cl. CPC G05D 1/2465; G05D 1/667; G06Q 10/087; G05D 2101/15; G05D 2105/285; G05D 2107/70; G05D 2109/10; G05D 2109/20

(57) ABSTRACT

A system and method for autonomously managing inventory in a warehouse environment is disclosed. The method includes accessing, via a plurality of sensor devices, data indicative of inventory within a warehouse. The method includes accessing, from a database, a multi-dimensional model of the warehouse. The method includes generating an updated multi-dimensional model of the warehouse based on the data indicative of the inventory within the warehouse. The method includes determining, using one or more machine-learned models (MLMs) and based on the updated multi-dimensional model of the warehouse, an action associated with the inventory of the warehouse. The method includes transmitting, over a network, instructions to a computing device to implement the action associated with the inventory of the warehouse.

### BACKGROUND

Effective supply chain planning relies on effective management of warehouse inventory. Many warehouses utilize a warehouse management system (WMS) that relies on human captured/entered data regarding inventory counts and the most up to date location of inventory.

### SUMMARY

In an aspect, the present disclosure provides an example computer-implemented method. The method may include accessing, via a plurality of sensor devices, data indicative of inventory within a warehouse. The method may include accessing, from a database, a multi-dimensional model of the warehouse. The method may include generating an updated multi-dimensional model of the warehouse based on the data indicative of the inventory within the warehouse. The method may include determining, using one or more machine-learned models (MLMs) and based on the updated multi-dimensional model of the warehouse, an action associated with the inventory of the warehouse. The method may include transmitting, over a network, instructions to a computing device to implement the action associated with the inventory of the warehouse.

In some embodiments, the plurality of sensor devices include at least one of (i) drones, (ii) forklifts with sensors, or (iii) mobile devices with cameras.

In some embodiments, the multi-dimensional model is a three-dimensional (3D) model and the updated multi-dimensional model is an updated 3D model.

In some embodiments, determining, using one or more MLMs and based on the updated multi-dimensional model of the warehouse, an action associated with the inventory of the warehouse includes generating, via one or more MLMs, based on the database, metrics associated with the warehouse and the inventory of the warehouse. In some embodiments, determining, using one or more MLMs and based on the updated multi-dimensional model of the warehouse, an action associated with the inventory of the warehouse includes determining the action based on the metrics.

In some embodiments, the metrics include dimensions associated with the warehouse. In some embodiments, the metrics include item counts associated with each item of the inventory of the warehouse.

In some embodiments, the action associated with the inventory of the warehouse includes a routing action, the routing action including a newly generated route for retrieving or locating one or more items of inventory for an order.

In some embodiments, the action associated with the inventory of the warehouse includes a storage action, the storage action indicating a location to store an item of the inventory.

In some embodiments, the action associated with the inventory of the warehouse includes a consolidation action, the consolidation action indicating two locations currently storing one or more types of items of the inventory.

In some embodiments, a first amount of the item at a first location of the two locations and a second amount of the item at a second location of the two locations are combinable to be stored together at the first location or the second location.

In some embodiments, the action associated with the inventory of the warehouse includes a drone routing action, the drone routing action including a route for a drone to travel.

In some embodiments, controlling the computing device includes transmitting instructions to the computing device.

In some embodiments, (i) the instructions are transmitted to a drone, the instructions instructing the drone to capture additional data or (ii) the instructions are transmitted to a mobile computing device, the instructions instructing the mobile computing device to display information via a user interface of the mobile computing device.

In some embodiments, the updated multi-dimensional model is stored in the database.

In an aspect, the present disclosure provides an example autonomous inventory management system. The autonomous inventory management system may include one or more processors and one or more tangible, non-transitory, computer-readable media that store instructions that are executable by the one or more processors to perform operations. The operations may include accessing, via a plurality of sensor devices, data indicative of inventory within a warehouse. The operations may include accessing, from a database, a multi-dimensional model of the warehouse. The operations may include generating an updated multi-dimensional model of the warehouse based on the data indicative of the inventory within the warehouse. The operations may include determining, using one or more machine-learned models (MLMs) and based on the updated multi-dimensional model of the warehouse, an action associated with the inventory of the warehouse. The operations may include transmitting, over a network, instructions to a computing device to implement the action associated with the inventory of the warehouse.

In some embodiments, the plurality of sensor devices include at least one of (i) drones, (ii) forklifts with sensors, or (iii) mobile devices with cameras.

In some embodiments, the multi-dimensional model is a three-dimensional (3D) model and the updated multi-dimensional model is an updated 3D model.

In some embodiments, determining, using one or more MLMs and based on the updated multi-dimensional model of the warehouse, an action associated with the inventory of the warehouse includes generating, via one or more MLMs, based on the database, metrics associated with the warehouse and the inventory of the warehouse. In some embodiments, determining, using one or more MLMs and based on the updated multi-dimensional model of the warehouse, an action associated with the inventory of the warehouse includes determining the action based on the metrics.

In some embodiments, the metrics include dimensions associated with the warehouse. In some embodiments, the metrics include item counts associated with each item of the inventory of the warehouse.

In some embodiments, the action associated with the inventory of the warehouse includes a routing action, the routing action including a newly generated route for retrieving one or more items of inventory for an order.

In an aspect, the present disclosure provides one or more example tangible, non-transitory, computer readable media storing instructions that are executable by one or more processors to perform operations. The operations may include accessing, via a plurality of sensor devices, data indicative of inventory within a warehouse. The operations may include accessing, from a database, a multi-dimensional model of the warehouse. The operations may include generating an updated multi-dimensional model of the warehouse based on the data indicative of the inventory within the warehouse. The operations may include determining, using one or more machine-learned models (MLMs) and based on the updated multi-dimensional model of the warehouse, an action associated with the inventory of the warehouse. The operations may include transmitting, over a network, instructions to a computing device to implement the action associated with the inventory of the warehouse.

Other example aspects of the present disclosure are directed to other systems, methods, vehicles, apparatuses, tangible non-transitory computer-readable media, and devices for performing functions described herein. These and other features, aspects and advantages of various implementations will become better understood with reference to the following description and appended claims. The accompanying drawings, which are incorporated in and constitute a part of this specification, illustrate implementations of the present disclosure and, together with the description, serve to explain the related principles.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 is a representation of an example warehouse environment, according to some implementations of the present disclosure.

FIG. 2 depicts an example computing ecosystem, according to some implementations of the present disclosure.

FIG. 3A is a representation of an example autonomous drone, according to some implementations of the present disclosure.

FIG. 3B is a representation of an example forklift, according to some implementations of the present disclosure.

FIG. 3C is a representation of an example mobile device, according to some implementations of the present disclosure.

FIG. 4 depicts an example dataflow pipeline, according to some implementations of the present disclosure.

FIG. 5 is a representation of an example multi-dimensional warehouse model, according to some implementations of the present disclosure.

FIG. 6 depicts an example data structure, according to some implementations of the present disclosure.

FIG. 7 depicts a flowchart of an example method, according to some implementations of the present disclosure.

FIG. 8 depicts an example computing ecosystem, according to some implementations of the present disclosure.

Repeat use of reference characters in the present specification and drawings is intended to represent the same or analogous features or elements of the present invention.

### DETAILED DESCRIPTION

The present disclosure relates to the computing architecture and computer-implemented processes of an autonomous inventory management system (AIMS). Warehouses and warehouse systems today rely heavily on human intervention in order to transport and track inventory within a warehouse, such that typical warehouse management systems (WMS) function primarily based on human entered and verified data. However, due to the high dependency on human actions and entries, WMSs are often inaccurate and non-optimal. This leads to problems affecting efficiency, storage optimization, and supply chain management. Such human-based updates to inventory counts and location may only be completed a couple of times a year, and thus, due to typical everyday actions that affect inventory within the warehouse, inventory may be displaced or unaccounted for. As such, typical WMS data may not be indicative of the actual inventory within the warehouse. For example, incorrect tracking of an item may lead to inaccurate inventory counts, difficulty or delays with pulling orders associated with the item, and future orders involving requests for non-optimal amounts of the item. Such inaccuracies can lead to unnecessary operation of warehouse equipment such as, for example, forklifts or other vehicles and monitoring drones that are instructed to retrieve items that are unavailable, store items in occupied areas, or perform other warehouse tasks. This results in wasteful use of battery power (or fuel) as well as increased mechanical wear and tear on the warehouse equipment, shortening the lifespan of the batteries and the equipment itself.

These technical problems may be solved by the autonomous inventory management system (AIMS) of the present disclosure and its related computer-implemented processes. For instance, the AIMS may include front-end hardware (e.g., drones, forklifts, sensors, mobile devices, etc.), a central back-end network system (e.g., servers, databases), and software (e.g., algorithms, machine learning models, heuristics, etc.). The AIMS may utilize these computing resources to accurately track the type, amount, and location of inventory as well as programmatically determine actions associated with the warehouse.

The AIMS may generate a multi-dimensional model of the warehouse based on collected visual data. For example, the front-end hardware devices of the AIMS may include sensors. These sensors may include visual sensors (e.g., cameras) or distance sensors (e.g., LIDARs, time of flight sensors, RADAR, etc.) capable of collecting visual data or distance data indicative of an environment surrounding the front-end hardware devices. The collected visual data may be associated with a location, such that the entirety of the warehouse may be mapped by utilizing one or more front-end hardware devices.

The collected data captured by the one or more front-end hardware devices may then be rendered such that the multi-dimensional model of the warehouse may be generated. The AIMS may utilize computer vision and/or machine-learned models (MLM) in order to determine objects within the collected visual data to generate the multi-dimensional model. For example, the AIMS may be capable of determining storage racks, inventory boxes, types of inventory, pallets, forklifts, trash cans, pallet wrappers, pallet jacks, etc.

Once the objects within the visual data are determined, the multi-dimensional model may be generated along with the objects. The objects generated within the model can accurately reflect the actual positions of the objects within the warehouse. Thus, an accurate digital multi-dimensional model of the warehouse may be generated and stored in order to determine insights relating to the warehouse. Furthermore, the multi-dimensional model may be a 2-dimenional model or a 3-dimensional model. Thus, locations associated with the digital data may be described using 2 coordinates (e.g., x and y coordinates) or 3 coordinates (e.g., x, y, and z coordinates).

The AIMS may update the multi-dimensional model of the warehouse in real-time and utilize the updated model to determine actions associated with the warehouse. For example, a computing system (e.g., a central AIMS computing system) can receive warehouse data indicative of inventory within the warehouse from the one or more front-end hardware devices. Once the visual data is captured, the data is stored in a database along with the location and time that the visual data was captured. In some implementations, the front-end hardware devices may include drones (e.g., autonomous aerial or ground-based drones). The drones may be stationed at a base (e.g., a landing pad) and deployable to traverse (e.g., fly around) the warehouse. The base may include a charging station and a router for network connection (e.g., via an internet).

The drones may operate on a scheduled time interval. For example, the drones may be programmed to traverse the warehouse and capture visual data (e.g., one drone may traverse the entire warehouse or multiple drones may each traverse a section of the warehouse). As such, the drones may traverse the warehouse and capture visual data associated with a current state of the warehouse. The drones may return to the base in order to upload the visual data to the computing system. The AIMS may use the newly captured visual data to update the previously generated multi-dimensional model of the warehouse.

The drones may wait a predetermined amount of time, traverse the warehouse again to capture new visual data of the warehouse (along the same or at least partially different route), and repeat the above process, such that the multi-dimensional model is updated over the scheduled time intervals.

In some implementations, the warehouse may be traversed in order to collect the visual data by any suitable devices or hardware, such as but not limited to forklifts, body cameras attached to workers, mobile devices with cameras, etc. Thus, visual data may be continuously collected by devices that move throughout the warehouse environment while completing other tasks not specifically associated with data collection. For example, a forklift equipped with a camera may drive throughout the warehouse to complete jobs such as, for example, picking orders or storing inventory. Thus, while the forklift is completing a job such as storing or picking, the camera positioned on the forklift may collect visual data of the warehouse environment and upload the data to the computing system for use in updating the multi-dimensional model.

MLMs may be trained to access, from the database, the multi-dimensional model of the warehouse in order to determine an action associated with the inventory of the warehouse. This may include accessing the most updated version of the multi-dimensional model. The action may be associated with controlling a hardware device associated with the warehouse. For example, the MLM may determine that a particular type of inventory is running low (e.g., there are low amounts of a particular inventory). As such, the MLM may determine that the appropriate action is for a computing system (e.g., associated with order placement) to request an order for more of the particular type of inventory. Furthermore, the MLM may determine that the particular type of inventory has been selling fast and may suggest to a computing system (e.g., associated with item storage such as an autonomous forklift) to store the particular type of inventory in an easy to access position (e.g., on a ground area rather than on top of a rack).

As another example, the MLM may determine that a pallet of inventory is currently stored in an incorrect area of the warehouse. For example, the warehouse may be arranged such that particular kinds of inventory are stored in certain sections and a particular item may be incorrectly located in an unassigned, less efficient, or inappropriate section. The MLM may determine that the appropriate action is to have an autonomous forklift move the pallet of inventory from the incorrect position to a correct position based on warehouse arrangement. However, if there is no available storage area in the correct position, the AIMS database is still able to accurately track the actual position of the inventory, such that if an order for the inventory is placed, the MLM may correctly advise retrieval of the inventory from the actual position of the inventory.

As another example, the MLM may determine that two pallets of the same inventory item are positioned at two separate locations. The MLM may also determine that a first amount of the item at a first location of the two locations and a second amount of the item at a second location of the two locations are combinable to be stored together at the first location or the second location. As such, the MLM may determine that the appropriate action is to combine the two pallets of the same inventory item. By combining the two pallets into one, more storage space may be allotted for a new pallet of inventory.

As yet another example, the MLM may determine that certain inventory needs to be picked for an order. As such, the MLM may determine that the appropriate action is to instruct an autonomous forklift (or its operator) to pick the inventory items associated with the incoming order. Furthermore, in order to assist with picking, the MLM may generate a route for picking the order. The route may include, for example, an optimized route that describes precisely what route to take and the exact locations of the required inventory based on the most recent version of the multi-dimensional model.

Once the actions have been determined by the MLM, the AIMS may control hardware devices to implement the actions. For example, the AIMS can control, over a network, a computing device to implement the action associated with the inventory of the warehouse. This can include, for example, transmitting, over the network, instructions to a computing device to implement the action associated with the inventory of the warehouse. In an example, the transmission is sent directly to one or more devices capable of implementing the instructions to complete the task. As previously discussed, devices (e.g., drones, forklifts, user devices, legged or wheeled robots such as humanoids or mobile manipulators, etc.) may have autonomous functionality, such that the AIMS can directly instruct devices to complete instructions associated with a determined action, without the need for human interaction. Additionally, or alternatively, the transmission is received by a device capable of displaying the instructions to one or more users of the AIMS. The one or more users of the AIMS may then utilize devices (e.g., forklifts, user devices, pallet jacks, etc.) to complete the action. In this manner, the instructions help increase optimization of hardware devices (e.g., robotic devices) within the warehouse that human based WMSs are incapable of providing. As will be further described herein, the AIMS can also accurately track warehouse inventory in order to provide helpful metrics to users, as well as utilize MLMs to automatically output optimization suggestions in order to streamline typical warehouse operations.

The technology disclosed herein provides a technical improvement by improving the functionality and performance of typical WMSs. For example, the AIMS and methods described herein improve existing systems by providing a continuously updated database which reflects current metrics associated with inventory stored within warehouses. The technology disclosed may obtain data used in the database via devices capable of visually capturing the warehouse environment, whereas existing systems require human assisted data entry which may lead to inaccuracies and less frequently updated databases. For example, existing WMSs may only receive data relating to metrics of warehouse inventory once an inventory item arrives at or departs the warehouse. Thus, any movement of the inventory item may not be accurately documented into the WMS database, which may lead to inefficient actions by warehouse equipment. Some current WMSs may also be updated by humans traversing the warehouse in order to periodically audit inventory (e.g., once every quarter, once every 6 months, once every year, etc.). However, auditing large warehouses may be highly inefficient and time consuming, while still risking the possibility of inaccurate data entry.

The AIMS and associated processes solve these technical problems through its generation of multi-dimensional models, deployment of trained MLMs, and usage of hardware devices. For example, one or more front-end hardware devices may be instructed to capture visual data indicative of the warehouse environment as often as may be preferred by the AIMS. The visual data may then be saved to the database, such that the database is updated regularly following every collection of visual data. This approach decreases the likelihood of the database being inaccurate, and thus provides an improvement to the typical method of updating databases via human data entry. Accordingly, the multi-dimensional model of the warehouse generated by the AIMS of the present disclosure is more accurate, leading to improved performance by the downstream MLM ingesting the model, and improved actions output by the MLM.

The technology of the present disclosure also improves the ability to communicate metrics associated with the inventory of the warehouse. For example, the ability to generate multi-dimensional models based on the database may help to more efficiently communicate metrics associated with the inventory. Typical WMS databases may only store data relating to inventory via text such as inventory amounts and location names. Such data may be difficult to visualize, and thus may lead to less optimization opportunities being realized. However, a multi-dimensional representation of the warehouse inventory may allow for easier understanding, which may lead to control actions that better utilize the power resources of the warehouse hardware, decreasing wear and tear on such equipment. The AIMS may receive data from enterprise resource planning (ERP) software and point of sale (POS) software, such that the AIMS may subsume, orchestrate, or fully replace traditional inventory and productivity software. For example, the AIMS may subsume, orchestrate, or replace current WMSs, labor management systems (LMS), or transportation management systems (TMS).

Additionally or alternatively, the AIMS may sync data and supply metrics across an entire supply chain. For example, the AIMS may coordinate inventory and metrics for a plurality of warehouse environments, such that warehouse environments not currently housing an inventory item may be prepared for when the inventory item does arrive. Furthermore, the AIMS may have access to manufacturing factories that manufacture inventory (e.g., the starting point of inventory items in the supply chain) and retail stores that sell inventory (e.g., the end point of inventory items in the supply chain). By tracking trends and analytics for inventory items throughout the entirety of the supply chain, MLMs may use the trends and analytics as training data to generate outputs that more efficiently forecast actions associated with future inventory.

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

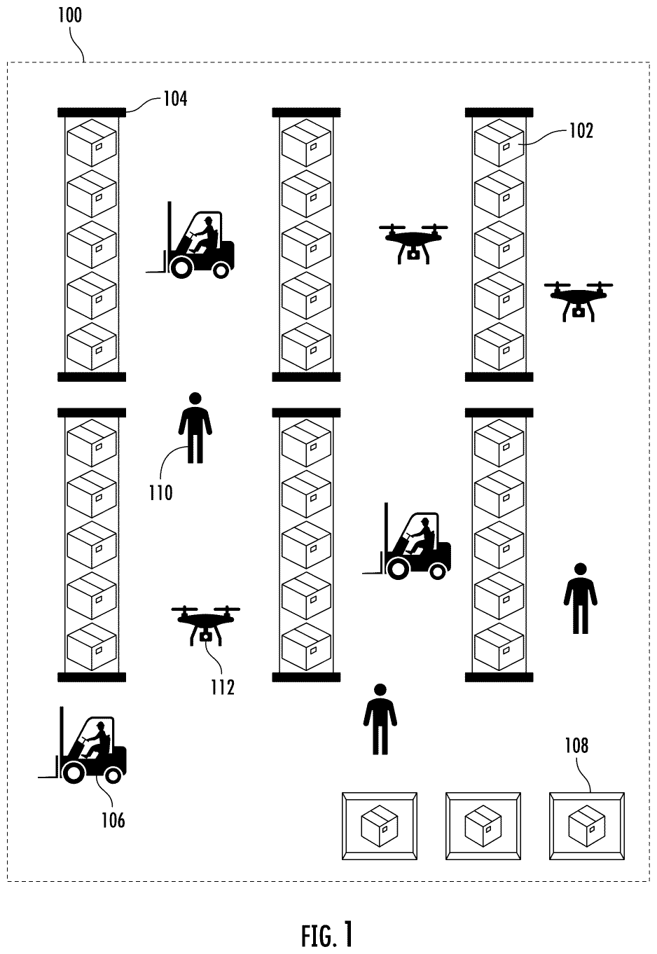

FIG. 1 is a representation of an example warehouse environment 100, according to some implementations of the present disclosure. A warehouse environment 100 can be any building or structure where manufactured goods or raw materials may be stored. In some examples, the warehouse environment 100 may include an indoor environment (e.g., within one or more facilities, etc.) or an outdoor environment. An indoor environment, for example, may be an environment enclosed by a structure such as a building (e.g., a service depot, maintenance location, manufacturing facility, etc.). An outdoor environment, for example, may be one or more areas in the outside world such as, for example, one or more rural areas suitable for storage of manufactured goods or raw materials (e.g., supply chain port, lumber yards, etc.).

The warehouse environment 100 may store inventory items (e.g., inventory) 102. The inventory 102 may include any storable item such as manufactured goods, raw materials, or the like (e.g., products, appliances, materials, spare parts, equipment, etc.). The inventory 102 can include boxes which contain a manufactured good or raw material. In some examples, inventory 102 can include other packaged or wrapped (e.g., storage wrapped) items. In some examples, inventory 102 can include bins or totes that store a manufactured good or raw material. In other examples, inventory 102 may not be packaged in any box, wrapping or storage material. In some examples, inventory 102 may include an identifier (e.g., barcode).

The inventory 102 may be positioned throughout the warehouse environment 100, such that each item of the inventory 102 may be accessible. For example, the inventory 102 may be stored on a storage rack 104. Storage racks 104 may be positioned in a predictable and repeatable pattern throughout the warehouse environment 100. In some examples, the storage racks 104 can be positioned in rows. In other examples, the storage racks 104 can be positioned adjacent to each other. In some examples, the storage racks 104 can be stacked on each other (e.g., in order to store more inventory 102 in a smaller square footage area).

The storage racks 104 can be of standard warehouse rack size or of custom size. In some examples, the storage racks 104 can be 8-feet, 10-feet, 12-feet, 16-feet, and 20-feet upright. In other examples, the storage racks 104 can be of a custom size (e.g., 11-feet, 11.5-feet, etc.). In some examples, the storage racks 104 can be based on the dimension(s) of inventory pallets. In other examples, the storage racks 104 can be based on the racking beam size.

The inventory 102 may be positioned on an inventory pallet 108. For example, inventory 102 may be tightly coupled with other similar items and stored on an inventory pallet 108 for easy storage and retrieval. In some examples, inventory pallets 108 may be stored on the storage racks 104. In other examples, inventory pallets may be stored on the floor of the warehouse environment 100. Furthermore, the inventory pallets 108 may be utilized by a forklift 106 in order to efficiently transport inventory 102.

Forklifts 106 may be utilized within a warehouse environment 100 in order to complete tasks associated with inventory 102. For example, forklifts 106 may be operable to transport inventory 102 from one location to another. In some examples, the forklifts 106 may be operated by an individual 110, such that the individual 110 controls the forklift 106 to transport inventory 102.

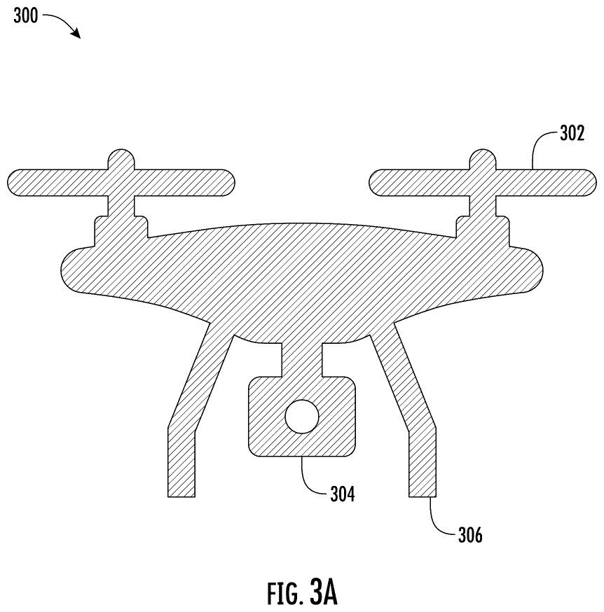

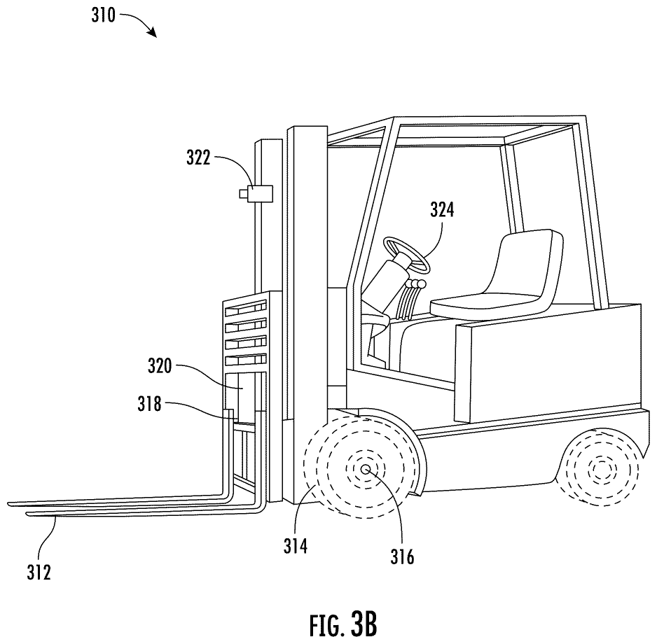

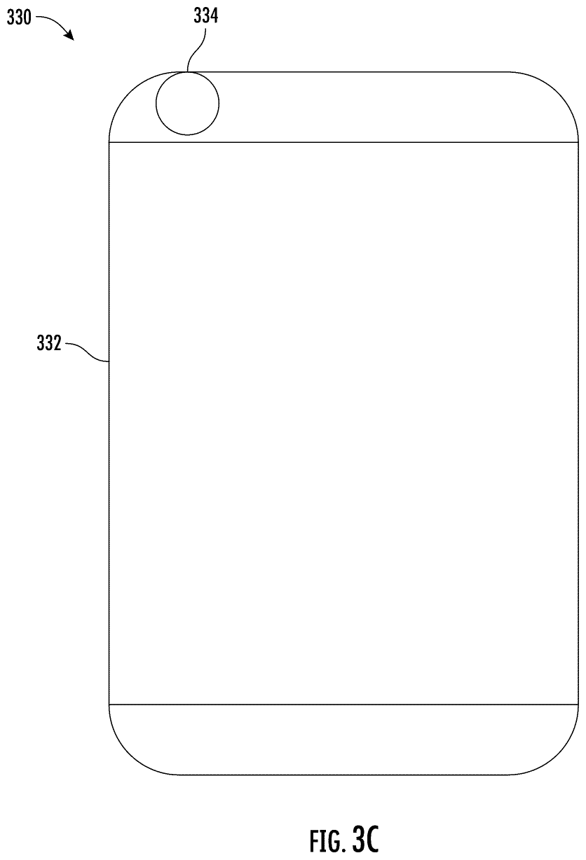

In other examples, the forklifts 106 may be autonomous forklifts. An autonomous forklift may receive instructions to complete a task without the need for an individual 110 to manually control the forklift 106. The warehouse environment 100 may include one or more forklifts 106. The one or more forklifts 106 may be electrically powered, gas powered or a combination of both. An example forklift will be described in greater detail below in FIG. 3B.

The warehouse environment 100 may further include one or more individuals (e.g., users, workers) 110. The individuals 110 may work or operate within the warehouse environment 100. In some examples, as previously discussed, individuals 110 may operate forklifts 106 (e.g., to pull orders or store inventory). In other examples, individuals 110 may oversee operations of the warehouse environment 100. As such, the individuals 110 may be positioned within or move around the warehouse environment 100. The individuals 110 may interact with one or more objects (e.g., as described herein) within the warehouse environment 100.

The warehouse environment 100 may include one or more autonomous drones 112. The autonomous drones 112 may be operable to navigate the warehouse environment 100 in order to track and record information associated with inventory 102 or operations within the warehouse environment 100. In some examples, the autonomous drone 112 may have a set flight path that the autonomous drone 112 completes over set intervals. In other examples, the autonomous drone 112 receives instructions indicating a specific flight path to follow. In some examples, the autonomous drone 112 may switch modes to be controlled by an individual 110. The one or more autonomous drones 112 may be electrically powered, gas powered, or some combination of both. An example autonomous drone will be described in greater detail below in FIG. 3A.

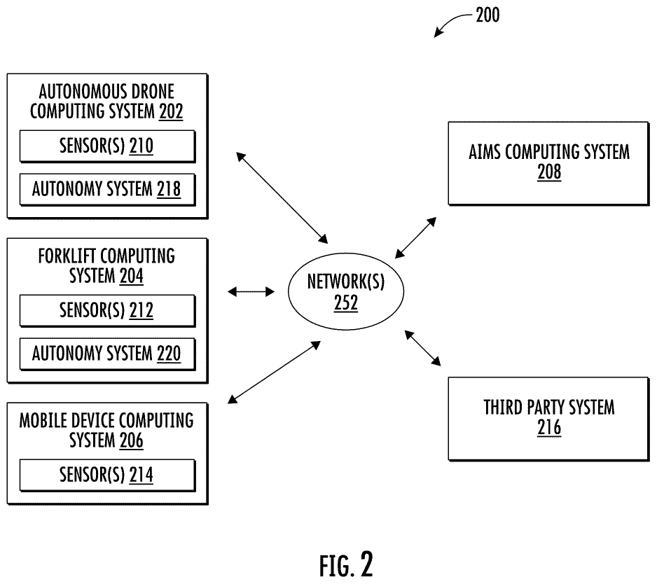

FIG. 2 depicts an example computing ecosystem 200, according to some implementations of the present disclosure. The example computing system 200 may include an autonomous drone computing system 202, a forklift computing system 204, and a mobile device computing system 206. The autonomous drone computing system 202, forklift computing system 204, and mobile device computing system 206 may each access one or more associated sensors 210, 212, 214 for collecting and sending data. In some examples, the sensors 210, 212, 214 may be various types of sensors including cameras, LIDAR, RADAR, visual recording sensors, heat sensing, audio sensors (e.g., microphones), tactile sensors, or other types of sensors. The example computing system 200 may include an AIMS computing system 208. The example computing system 200 may further include a third party system 216. The third party system 216 may host, provide, be accessed via, or communicated with using one or more application programming interfaces (APIs).

The above described systems may be communicatively coupled over one or more networks 252. In some examples, the autonomous drone computing system 202, forklift computing system 204, and mobile device computing system 206 may each separately communicate with the AIMS computing system 208 over the one or more networks 252. In other examples, the autonomous drone computing system 202, forklift computing system 204, and mobile device computing system 206 may communicate with one another and the AIMS computing system 208.

In some implementations, the autonomous drone computing system 202 may be included in an autonomous drone 112. For example, the autonomous drone computing system 202 may be located onboard an autonomous drone 112 and implement an autonomy system for autonomously operating the autonomous drone 112. In other implementations, the autonomous drone computing system 202 may not be located onboard an autonomous drone 112. For example, the autonomous drone 112 may include one or more distinct physical autonomous drone computing systems 202. The autonomous drone computing system 202 may access one or more sensors 210 associated with the autonomous drone 112. In some examples, the autonomous drone computing system 202 may relay instructions to the one or more sensors 210. The instructions may instruct the autonomous drone 112 to collect data (e.g., warehouse environment data, inventory data, etc.) using one or more sensors 210. In other examples, the autonomous drone computing system 202 may transmit the data captured by one or more sensors 210 over the network(s) 252.

The autonomous drone computing system 202 may include an autonomy system 218. For example, the drone (e.g., autonomous drone 112) can include various systems to allow the drone to operate autonomously (e.g., with little or no input from an operator). The drone can include a routing system, a positioning system, a motion planning system, and one or more vehicle control systems. The routing system can generate (onboard the drone) and/or obtain (from autonomous drone computing system 202) a route for the drone to follow from one location to one or more other locations. The positioning system can determine a current position of the drone. The positioning system can be any device or circuitry for analyzing the position of the drone. For example, the positioning system can determine position by using inertial sensors, a global positioning system/satellite positioning system, based on IP/MAC address, by using triangulation and/or proximity to network access points or other network components (e.g., cellular towers and/or Wi-Fi access points) and/or other suitable techniques. The position of the drone can be used by various systems of the autonomous drone computing system 202 and/or provided to one or more remote computing devices (e.g., cloud services system).

The drone can identify its position within its environment and/or along a route. The drone can obtain map data that can provide the drone relative positions of the surrounding environment of the vehicle (e.g., building interiors, etc.). The drone can obtain route data indicative of a route to be followed (e.g., to travel from one aerial facility to another). The drone can identify its position within the surrounding environment based at least in part on the data described herein to help follow along the route. For example, the drone can process sensor data (e.g., LIDAR data, camera data, positioning data, etc.) from sensors onboard the drone (e.g., drone sensors 210) to match it to a map of the surrounding environment and/or a route to get an understanding of the drone's position within that environment and/or along the route (e.g., transpose the drone's position within its surrounding environment/route). The autonomous drone 112 can process the sensor data to determine objects within its surroundings and plan its motion according to the map data and sensor data. The autonomous drone 112, and operability thereof, will be described in greater detail below.

In some implementations, the forklift computing system 204 may be included in a forklift 106. For example, the forklift computing system 204 may be located onboard a forklift 106. In other implementations, the forklift computing system 204 may not be located onboard a forklift 106. For example, the forklift 106 may include one or more distinct physical forklift computing systems 204. The forklift computing system 204 may access one or more sensors 212 associated with the forklift 106. In some examples, the forklift computing system 204 may relay instructions to the one or more sensors 212. The instructions may instruct the forklift 106 to collect data (e.g., warehouse environment data, inventory data, etc.) using one or more sensors 212. In other examples, the forklift computing system 204 may transmit the data captured by one or more sensors 212 over the network(s) 252. The forklift 106, and operability thereof, will be described in greater detail below.

The forklift 106 may be an autonomous forklift. As such, the forklift computing system 204 may include an autonomy system 220 configured to operate forklift 106 autonomously or semi-autonomously. The autonomy system 220 may be implemented by one or more onboard computing devices. This may include one or more processors and one or more memory devices. The one or more memory devices may store instructions executable by the one or more processors to cause the one or more processors to perform operations or functions associated with the subsystems. The computing resources of the autonomy system 220 may be shared among its subsystems, or a subsystem may have a set of dedicated computing resources.

The autonomy system 220 may implement one or more autonomy operations. The autonomy operations may include perceiving the surrounding environment of the forklift 106, capturing forklift operation data (e.g., data describing the operation of the forklift 106 as it operates), and planning the forklift's motion through the warehouse environment 100, with or without manual human input.

Example subsystems of the autonomy system may include a forklift localization system, motion planning system, and forklift control system. The forklift localization system may determine the location of the forklift 106 within the warehouse environment 100. For example, the forklift localization system may pinpoint the exact location of forklift 106 based on forklift operation data and data captured by sensor(s) 212. This can include localizing the forklift 106 by comparing image data to a map of known aspects within the warehouse environment 100. The motion planning system may determine a motion plan including a forklift behavior and/or a path (e.g., route) of travel for forklift 106. The path of travel may include one or more trajectories that indicate a path for the forklift 106 to follow through the warehouse environment 100. The forklift control system may translate the one or more trajectories into vehicle controls for controlling the forklift 106. For example, the forklift 106 may include control devices which may include different subsystems for performing various forklift control operations. The forklift data captured by the autonomy system 220 may serve as ground truth data for the MLMs of the AIMS to drive future improvements to forklift productivity, as will be discussed in greater detail below.

In some implementations, the mobile device computing system 206 may be included in a mobile device. The mobile device may include a phone, tablet, laptop, wearable computing device (e.g., smartwatch), virtual reality (VR) device (e.g., VR headset), augmented reality (AR) device (e.g., AR headset), body camera, etc. In some examples, the mobile device may be operated by an individual 110. In other examples, the mobile device may operate autonomously (e.g., affixed to a drone or forklift).

The mobile device computing system 206 may be located onboard a mobile device. In other implementations, the mobile device computing system 206 may not be located onboard a mobile device. For example, the mobile device may include one or more distinct physical mobile device computing systems 206. The mobile device computing system 206 may access one or more sensors 214 associated with the mobile device. In some examples, the mobile device computing system 206 may relay instructions to the one or more sensors 214. The instructions may instruct the mobile device to collect data (e.g., warehouse environment data, inventory data, etc.) using one or more sensors 214. In other examples, the mobile device computing system 206 may transmit the data captured by one or more sensors 214 over the network(s) 252. The mobile device, and operability thereof, will be described in greater detail below.

The AIMS computing system 208 may communicate with the autonomous drone computing system 202, forklift computing system 204, and mobile device computing system 206 over network(s) 252 in order to receive data captured by the sensors 210, 212, 214. The AIMS computing system 208 may then store and manipulate this data, as will be described in greater detail herein. The AIMS computing system 208 may further communicate with a third party system 216 via the network(s) 252. In some examples, the AIMS computing system 208 may transmit information associated with the data (e.g., instructions, insights, programs, etc.) to the third party system 216. In other examples, the AIMS computing system 208 may transmit information associated with the data (e.g., instructions, insights, programs, etc.) back to the autonomous drone computing system 202, forklift computing system 204, or mobile device computing system 206 via the network(s) 252.

The third party computing system 216 may be a computing system separate from the AIMS computing system 208. For example, the third party computing system 216 may operate to provide information to the AIMS computing system 208 or may receive outputs from the AIMS computing system 208.

In some examples, the third party computing system 216 may provide the AIMS computing system 208 information that may not be obtainable by the sensors associated with other computing systems. For example, the information may include specific order information relating to amounts of inventory planning to enter or leave the warehouse. Furthermore, the information may include shipment tracking information relating to times, time periods, days, etc. that the shipments are expected to arrive at or depart the warehouse environment 100. Such information may be important for the AIMS computing system 208 to consider when optimizing operations associated with the warehouse environment 100.

In other examples, the third party computing system 216 may receive outputs from the AIMS computing system 208. As such, the third party system may manipulate or otherwise transform the output from AIMS computing system 208 such that the outputs may be ready for display via a plurality of different computing systems or formats. Similarly, the third party computing system 216 may be a computing system outside of the warehouse environment scope (e.g., a customer computing system that ordered inventory from the warehouse environment 100). In such embodiments, the third party computing system 216 may receive outputs such as order information or shipment tracking information. The information may be provided from the AIMS computing system 208 to the third party computing system 216 via an API.

FIG. 3A is a representation of an example autonomous drone 300 (e.g., autonomous drone 112), according to some implementations of the present disclosure. The autonomous drone 300 may be an electrically powered drone or a gas powered drone. The autonomous drone 300 may include a motor or engine respectively, which powers one or more propellors 302. The autonomous drone 300 may include any number of propulsion mechanisms (e.g., propellors) 302 such as, but not limited to, 1 propellor, 2 propellers, 4 propellors, 6 propellors, etc. The propellors 302 may function to propel the autonomous drone 300 through the air, such that the autonomous drone 300 may navigate the warehouse environment 100. In some examples, a motor which powers the propellors 302 may receive predetermined instructions from the autonomous drone computing system 202 to supply power to the propellors 302. In other examples, the autonomous drone 300 may be manually controlled using a remote device (e.g., controller). For example, the autonomous drone 300 may be manually controlled by an individual 110.

The autonomous drone 300 may include a drone sensor(s) 304 (e.g., sensor 210). Drone sensor(s) 304 may include one singular sensor or a plurality of different sensors. In some examples, drone sensor 304 may include a visual sensor (e.g., camera) for capturing a current status of the warehouse environment 100. Furthermore, the drone sensor 304 may capture a status of objects within the warehouse environment 100 (e.g., inventory, forklifts, storage racks, etc.). In other examples, the drone sensor 304 may include a ranging sensor for mapping an area (e.g., LiDAR sensor). As such, the autonomous drone 300 may be capable of collecting data for mapping the warehouse environment 100 as it navigates through the warehouse environment 100. In some implementations, the autonomous drone 300 (e.g., the autonomous drone computing system 202) may map the warehouse as it navigates. The autonomous drone 300 may utilize the ranging sensor to implement the autonomous features of the autonomous drone 300. In some implementations, the drone sensor 304 may be facing forward, such that the drone sensor 304 captures data based on where the front of the autonomous drone 300 is facing. In other implementations, the drone sensor 304 may be facing a different direction. For example, the drone sensor 304 may rotate such that the drone sensor 304 may capture a full 360-degree field of view.

The autonomous drone 300 may include landing gear components 306. The landing gear components 306 may be provided as one or more legs, such as but not limited to, 2 legs, 4 legs, 6 legs, etc. Autonomous drone 300 may utilize the landing gear components 306 to safely take-off and land autonomous drone 300. The landing gear components 306 may be configured to land at or on a landing pad. In some implementations, the autonomous drone 300 and the landing pad can communicate through a contact connection (e.g., wired ethernet connection) when the autonomous drone 300 is docked on the landing pad. In other implementations, the autonomous drone 300 and the landing pad can communicate over a wireless connection (e.g., wireless local area network (WLAN), wireless wide area network (WWAN), near-field communication, other shorter distance communication protocols, etc.) while the autonomous drone 300 is in-flight. In some implementations, the autonomous drone 300 or the landing pad can implement one or more of the systems, operations, or functionalities described herein for validating one or more systems or operational systems.

FIG. 3B is a representation of an example forklift 310 (e.g., forklift 106), according to some implementations of the present disclosure. The forklift 310 may be an electrically powered forklift or a gas-powered forklift. The forklift 310 may be autonomous or may be manually controlled by a user (e.g., individual 110). In some examples, the forklift 310 may be both autonomous and manually controlled, and may switch between the two configurations. The forklift 310 may be operable to transport one or more inventory items 102 throughout the warehouse environment 100. The forklift 310 may include a front-end load portion. The front-end load portion of forklift 310 may include one or more forks 312. In some examples, the forks 312 may be positioned underneath an inventory item 102 to lift and transport inventory item 102. In other examples, the inventory item 102 may be placed on a pallet 108. The forks 312 may then be positioned in one or more open slots of the pallet 108 in order to more easily lift and transport inventory item 102.

The front-end load portion may further include a carriage 318 and a load backrest 320. The carriage 318 and load backrest 320 may function to support the inventory 102 and the pallet 108 as it is lifted by the forks 312. For example, the front-end of the forklift 310 may be operable to tilt back once inventory 102 has been lifted by the forks 312. The carriage 318 and load back rest 320 may help to support the weight of inventory 102 as the inventory 102 is tilted back.

The forklift 310 may include one or more wheels 314 and a drive axle 316. As previously discussed, the forklift 310 may be electrically powered or gas powered. As such, the forklift 310 may include a motor or an engine respectively. The motor or engine may provide power to the drive axle 316. The drive axle 316 may rotate the wheels 314 in order to move the forklift 310 throughout its environment.

The forklift 310 may include a forklift sensor(s) 322 (e.g., sensor 212). Forklift sensor(s) 322 may include one singular sensor or a plurality of different sensors. In some examples, forklift sensor 322 may include a visual sensor (e.g., camera) for capturing a current status of the warehouse environment 100. Furthermore, the forklift sensor 322 may capture a status of objects within the warehouse environment 100 (e.g., inventory, forklifts, storage racks, etc.). In other examples, the forklift sensor 322 may include a ranging sensor for mapping an area (e.g., LiDAR sensor). As such, the forklift 310 may be capable of collecting data for mapping the warehouse environment 100 as it navigates the warehouse environment 100. The forklift 310 may utilize the ranging sensor to implement autonomous features of the forklift 310. The forklift sensor 322 may be positioned on any portion of the forklift 310. For example, the forklift sensor 322 may be positioned on a front-end of the forklift 310, such that the forklift sensor 322 captures data based on where the front of the forklift 310 is facing. In other implementations, the forklift sensor 322 may be facing a different direction. For example, the forklift sensor 322 may rotate such that the forklift sensor 322 may capture a full 360-degree field of view.

The forklift 310 may include an interior cab portion. As previously discussed, the forklift 310 may be manually controlled. In such implementations, the forklift may utilize the interior cab portion in order to house a user during operation of the forklift 310. The interior cab portion may include a steering wheel 324. A user may utilize the steering wheel 324 in order to navigate the forklift 310 through the warehouse environment 100.

FIG. 3C is a representation of an example mobile device 330, according to some implementations of the present disclosure. The mobile device 330 may be provided as any computing device such as, but not limited to, a phone, tablet, laptop, wearable computing device (e.g., smartwatch), virtual reality (VR) device (e.g., VR headset), augmented reality (AR) device (e.g., AR headset), body camera, etc. The mobile device may include a display 332. The display 332 may display features or elements to a user. The display 332 may be provided as a touchscreen, wherein the display may receive one or more manual inputs and display one or more visual outputs. In some implementations, the display 332 may be positioned on a frontside of mobile device 330. In other implementations, the display 332 may be positioned on a backside of mobile device 330.

The mobile device may include a mobile device sensor(s) 334 (e.g., sensor 214). Mobile device sensor(s) 334 may include one singular sensor or a plurality of different sensors. In some examples, mobile device sensor 334 may include a visual sensor (e.g., camera) for capturing a current status of the warehouse environment 100. Furthermore, the mobile device sensor 334 may capture a status of objects within the warehouse environment 100 (e.g., inventory, forklifts, storage racks, etc.). In other examples, the mobile device sensor 334 may include a ranging sensor for mapping an area (e.g., LiDAR sensor). In some examples, a user (e.g., individual 110) may carry mobile device 330 as the user navigates the warehouse. In other examples, mobile device 330 may be positioned on items (e.g., drones, forklifts, pallet jacks, pallets, storage racks, etc.) within the warehouse environment 100, such that the mobile device 330 may capture data from the perspective of the item that the mobile device 330 is positioned on. As such, the mobile device 330 may be capable of collecting data for mapping the warehouse environment 100. In some implementations, the mobile device sensor 334 is positioned on the opposite side of mobile device 330 as display 332. In other implementations, the mobile device sensor 334 is positioned on the same side of mobile device 330 as display 332.

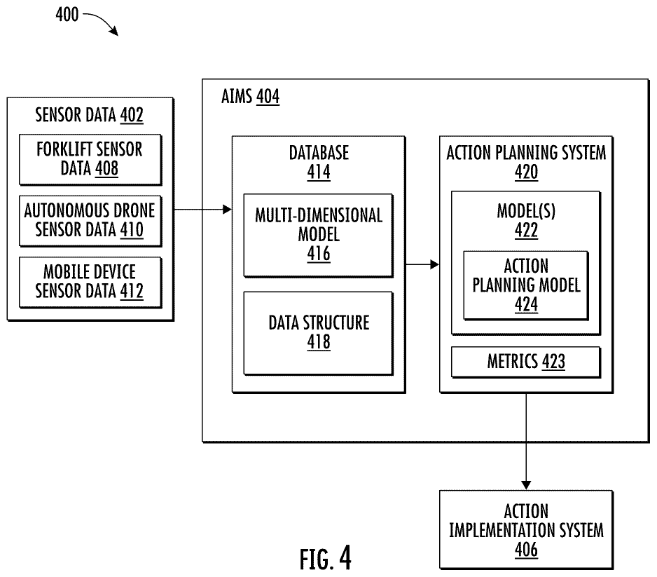

FIG. 4 depicts an example dataflow pipeline 400, according to some implementations of the present disclosure. The example data flow pipeline 400 depicts an example implementation in which sensor data 402 is passed from a plurality of sensors to the AIMS 404 for manipulation and storage. Using the sensor data 402, the AIMS 404 may update a database and plan an action associated with the warehouse environment 100. The action implementation system 406 may then output instructions to complete the determined action. The action may be an action associated with the warehouse environment 100 (e.g., storage, retrieval, inventory combining, data collection, etc.).

The sensor data 402 may include forklift sensor data 408, autonomous drone sensor data 410, and mobile device sensor data 412. The forklift sensor data 408, autonomous drone sensor data 410, and mobile device sensor data 412 may be data collected by sensors 212, 210 and 214 respectively. As previously discussed, sensors associated with autonomous drone 112, forklift 106, and the mobile device 330 may collect data as they are moved throughout the warehouse environment 100. In some instances, the sensor data 402 is collected constantly, such that while other actions not directly associated with data collection are occurring (e.g., a forklift transporting inventory, an individual holding a mobile device while walking through the warehouse environment, etc.), the forklift sensor data 408, autonomous drone sensor data 410, and mobile device sensor data 412 may still be concurrently collected.

In some instances, the sensor data 402 may be collected in planned intervals. For example, one or more autonomous drones 112 may be ordered to navigate the warehouse environment 100. As the one or more autonomous drones navigate the warehouse environment 100, sensors associated with the autonomous drones 112 may collect data indicative of a current status of the warehouse environment 100.

The sensor data 402 may include or be provided as pictures, video, a three-dimensional occupancy view, timestamps, barcodes labels, case dimensions, case counts, inventory specifics, etc. In some examples, the sensor data 402 may be raw visual data captured by one or more sensors and transmitted to the AIMS 404. In other examples, the sensors may scan their environments and capture specific data (e.g., scanning bar codes in real time to determine an inventory type).

The AIMS 404 may receive sensor data 402 indicative of the current status of the warehouse environment 100 from any combination of autonomous drones 112, forklifts 106 and mobile devices 330. The AIMS 404 may include a database 414 for storing sensor data 402 and an action planning system 420 for making determinations based on the stored sensor data 402. The database 414 may further include a multi-dimensional model 416 and a data structure 418. The action planning system 420 may include one or more machine-learned models 422 and an action planning model 424.

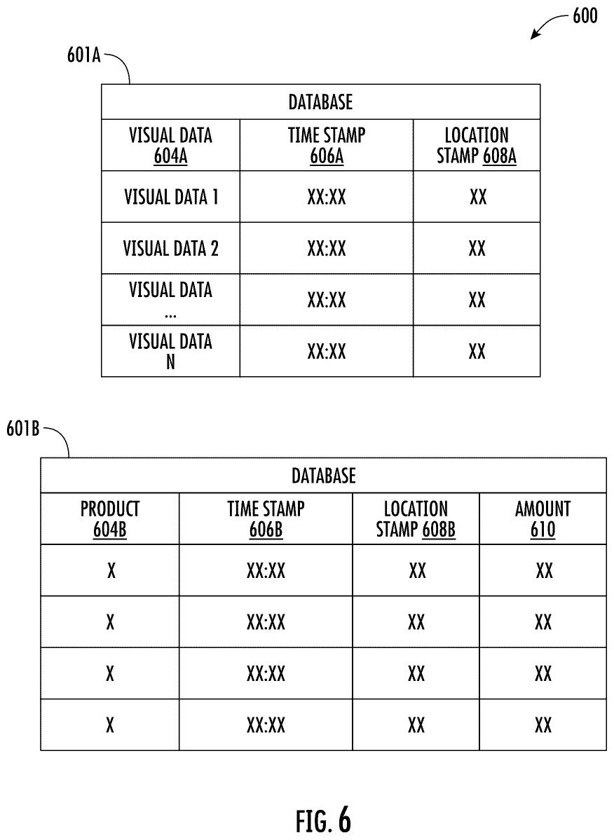

The data structure 418 may include one or more types of data structures including, for example, arrays, tables, lists, etc. For instance, the data structure 418 may be provided as a large time series data table that stores data entries associated with the sensor data 402. For example, the data structure 418 may store and correlate the visual sensor data 402 with a timestamp and a location at which the sensor data 402 was collected. The timestamp and location may be determined via a GPS tracker (or other type of device) associated with the sensor responsible for capturing the sensor data. In some examples, the GPS tracker may be implemented into the sensor. In other examples, the GPS tracker may be attached to a device (e.g., autonomous drone, forklift, mobile device) responsible for navigating the sensor through the warehouse environment 100. Furthermore, the device may be capable of calculating its current position through one or more positioning techniques, as previously discussed. The data structure 418 will be discussed in greater detail in FIG. 6.

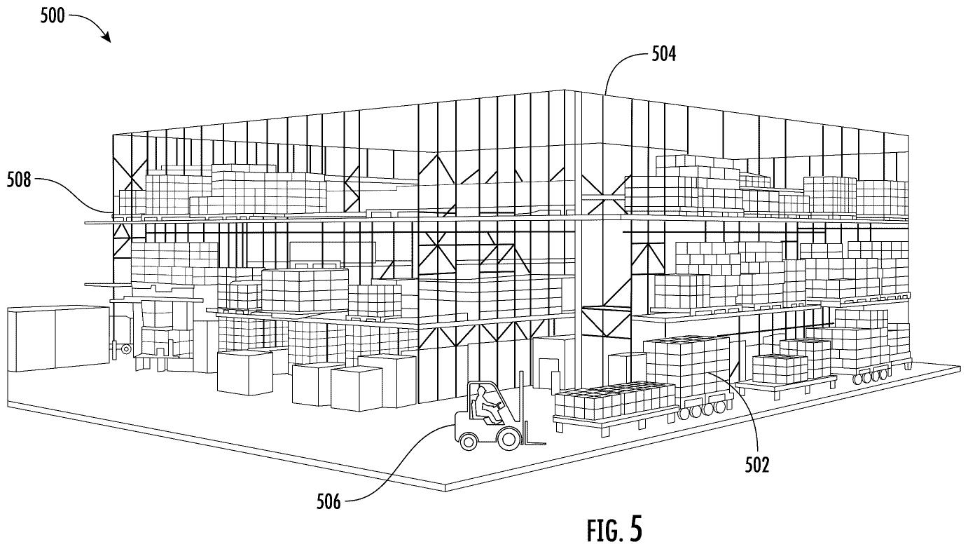

The multi-dimensional model 416 may be provided as a virtual model of the warehouse environment 100. The virtual model may be a two-dimensional or three-dimensional model, such that the warehouse environment 100 may be accurately portrayed by the virtual model. The multi-dimensional model 416 may be generated directly based on the data (e.g., sensor data 402) stored in the data structure 418. As such, updating the data structure 418 may cause an updated multi-dimensional model 416 to be generated. In some examples, an updated multi-dimensional model 416 may be generated whenever data within the data structure 418 is changed (e.g., added, deleted, updated, edited, etc.). In other examples, a new updated multi-dimensional model 416 may be generated over set intervals of time. For example, a new updated multi-dimensional model 416 may be generated every hour, every day, every week, etc. Thus, the multi-dimensional model 416 may update as often as a user of the AIMS 404 requests. The multi-dimensional model 416 will be described in greater detail in FIG. 5.

Once the sensor data 402 has been processed and stored in data structure 418, the sensor data 402 may be accessed and enriched by a mix of traditional software (e.g., computer vision) and one or more machine-learned models (MLMs). In some examples, the sensor data 402 may be analyzed to determine that a pallet of inventory was stored at a specific location at a specific time. Based on the location, the type of inventory may be determined based on a mapping of inventory and usual storage locations. Additionally or alternatively, a barcode can be recognized and read to determine the type of inventory. Furthermore, the amount of barcodes and dimensions of the pallet may be analyzed to determine an exact case count or inventory count based on the captured sensor data 402. By applying computer vision and MLMs to the information and sensor data 402 stored in the data structure 418, a plurality of objects can be determined from the sensor data 402, such that the warehouse environment 100 may be virtually recreated from sensor data 402 in the form of the multi-dimensional model 416. For example, the AIMS 404 may be capable of determining and identifying storage racks, inventory boxes, types of inventory, pallets, forklifts, trash cans, pallet wrappers, pallet jacks, people, etc. Such determinations may then be used to generate the multi-dimensional model 416.

The action planning system 420 may access the data structure 418 and multi-dimensional model 416. The action planning system 420 may include one or more models 422. The models 422 may include a wide range of models such as, but not confined to, image recognition models, object detection models, world generation models, natural language processing models, learning object metadata models (LOM), large language models (LLM), large world models (LWM), large vision models (LVM), models in pure embedding space with multimodal data, etc. The action planning system 420 may utilize the one or more models 422 to generate a set of metrics 423 associated with the warehouse environment 100 and the inventory 102 by feeding the data associated with the data structure 418 and the multi-dimensional model 416 to the models 422.

In some examples, the models 422 may generate the set of metrics 423 by comparing data associated with a current status of the warehouse (e.g., data recently received by one or more sensors) to a baseline dataset. The baseline dataset may be representative of a preferred status of the warehouse environment 100. The baseline dataset may change over time depending on operations of, or preferences related to, the warehouse environment 100 (e.g., storage capabilities of the warehouse environment, the amount of inventory shipped and received, how long inventory is stored at the warehouse environment, etc.). The baseline dataset may also differ from warehouse environment to warehouse environment, such that the baseline dataset used by a particular warehouse environment 100 is determined specifically for that warehouse environment 100. For example, a baseline dataset may include a preferred case count for a particular item of inventory 102 to be stored at the warehouse environment 100 in order to provide for incoming orders. The models 422 may then compare the data in the data structure 418 and multi-dimensional model 416 (e.g., the actual case count of the particular item of inventory) to the baseline dataset (e.g., the preferred case count of the particular item of inventory) and determine metrics 423 associated with the particular item of inventory 102. For example, the models 422 may determine that there is too much or too little of the particular type of inventory.

Additionally or alternatively, the baseline dataset may include a preferred storage rack capacity (e.g., amount of inventory 102) of the warehouse environment 100. For example, the baseline dataset may include a preferred storage rack capacity amount (e.g., 85% full). The models 422 may access the multi-dimensional model 416 in order to determine what percentage of storage rack capacity of warehouse environment 100 is currently full. As such, the metrics 423 determined by models 422 may portray that the storage racks 104 are currently less full (e.g., 75%) than the preferred storage rack capacity amount or that the storage racks 104 are currently more full (e.g., 95%) than the preferred storage capacity amount.

In other examples, the metrics 423 may include other information associated with the warehouse environment 100, such as available warehouse storage space, how full each pallet is and whether multiple pallets may be consolidated, order information, shipment information, arrival information, route optimization, etc.

The action planning system 420 may access the metrics 423 associated with the warehouse environment 100 and the inventory 102 and determine an action associated with the warehouse environment 100. For example, the action planning model 424 may generate a plan to implement the determined action based on the metrics 423. The action planning model 424 may be provided as a machine-learned model separate from models 422 or as part of models 422. Additionally, or alternatively, the action planning model 424 may include heuristics or rules-based models. In some implementations, the action planning model 424 may include one or more look-up tables that indicate an action to be undertaken based on a given set of metrics 423.

In some examples, the action planning model 424 may receive the metrics 423 directly from one or more other models 422. Additionally, or alternatively, the metrics 423 may be stored in an intermediate medium and the action planning model 424 may access the metrics 423 therefrom.

The action planning model 424 may determine whether to implement an action and, if so, what action to undertake. The action planning model 424 may make such determinations at discrete times, over set intervals of time, following an update to the database 414 of the AIMS 404, etc.

For example, the action planning model 424 may access the metric 423 that portrayed the warehouse environment 100 is currently storing too much or too little of a particular item of inventory 102. The action planning model 424 may then determine whether to plan an action in order to account for the metric 423. The action planning model 424 may make the determination based on whether the actual case count of the particular item of inventory 102 is outside of a threshold amount from the preferred case count of the particular item of inventory 102. If the actual case count is within a threshold amount from the preferred case count, the action planning model 424 may determine not to plan an action. If the actual case count is outside of a threshold amount from the preferred case count, the action planning model 424 may determine to plan an action. If the action planning model 424 determines to plan an action, the action may differ based on if the actual case count is less than or more than the preferred case count. If the actual case count is less than the preferred case count, the action planning model 424 may determine an action that involves ordering more cases of the particular item of inventory 102. If the actual case count is more than the preferred case count, the action planning model 424 may determine to forego ordering more of the particular item of inventory (e.g., wherein inventory may be ordered monthly to keep up with demands) until the actual case count is within the threshold amount from the preferred case count.

Additionally or alternatively, the action planning model 424 may access the metric 423 that portrayed the storage racks are currently less full or more full than the preferred storage rack capacity amount. Similarly, the action planning model 424 may determine whether or not to plan an action based on if the actual storage rack capacity amount is within a threshold percentage of the preferred storage rack capacity. If the action planning model 424 determines to plan an action, the action may differ based on if the storage rack capacity amount is less than (e.g., less full) or more than (e.g., more full) the preferred storage rack capacity. For example, if the storage racks 104 are less full than the preferred storage rack capacity, the action planning model 424 may determine that more inventory can be ordered or that inventory not currently stored in racks (e.g., such as on the ground or another holding area) may be moved to the storage racks. If the storage racks 104 are more full than the preferred storage rack capacity, the action planning model 424 may determine to consolidate one or more pallets containing like inventory as will be described in more detail below.

In other examples, the determined action may include a routing action. The routing action may include a newly generated route for retrieving or locating one or more items of inventory 102 for an order. The newly generated route may depend on a current (e.g., recently updated) status of the warehouse environment 100 (e.g., rather than an outdated status of the warehouse environment 100), and as such, the newly generated route may be optimized for the current status of the warehouse environment 100. For example, an order may be placed for a plurality of items of inventory 102. The order may need to be picked by an individual 110 by navigating through the warehouse environment 100 to each ordered item of the inventory 102 and manually picking each item. In order to optimize this process, one or more models 422 may access the multi-dimensional model 416 to determine metrics 423 such as a distance between each location of each item of inventory 102 for the order. Action planning model 424 may then access these distances via metrics 423 and the layout of the warehouse environment 100 via the multi-dimensional model 416 to determine the most efficient path (e.g., the least amount of total distance traveled, the best order for stacking items of inventory 102, etc.) for picking the items that have been ordered.

Additionally, or alternatively, the determined action may include a storage action. The storage action may indicate a location to store an item of the inventory 102. Since the multi-dimensional model 416 depicts currently empty and currently filled storage locations, the action planning system 420 can determine an optimized location to store the item of inventory 102.

As previously discussed, the determined action may include a consolidation action. The consolidation action may indicate two locations currently storing one or more types of items of inventory 102. For example, a first amount of an item may be stored at a first location and a second amount of the item may be stored at a second location. The action planning system 420 may utilize one or more models 422 to determine that the first amount of the item is equal to a first percentage amount of a full pallet capacity (e.g., 60% of the full pallet capacity). The one or more models 422 may also determine that the second amount of the item is equal to a second percentage amount of the full pallet capacity (e.g., 30% of the full pallet capacity). The models 422 may determine such metrics 423 by accessing an updated version of the multi-dimensional model 416 and accessing an associated case count for each stored pallet of inventory 102. As such, the action planning model 424 may determine that the first amount and the second amount are combinable to be stored together and consolidated onto a single pallet (e.g., 90% of the full pallet capacity). Action planning model 424 may then determine that an action is to be taken and may plan the action to consolidate the two amounts by outputting instructions to transport one or both amounts of the item such that a consolidated pallet is created. The consolidated pallet may be stored at the first location, the second location, or a new location. By combining the first amount and the second amount, available storage area may be increased, therefore improving warehouse storage efficiency.

Additionally, or alternatively, the determined action may include a drone routing action. The drone routing action may include a route for a drone (e.g., autonomous drone 112) to travel. For example, a certain area of the multi-dimensional model 416 may need to be updated. As such, the action planning system 420 may determine that one or more drones need to navigate to the warehouse environment location associated with the area of the multi-dimensional model 416 that needs to be updated (e.g., to capture updated sensor data). In order to instruct the drones to navigate, the models 422 may access the multi-dimensional model 416 to determine metrics 423 associated with air travel. For example, the models 422 may determine the shortest path from the current location of a drone to the warehouse environment location. Additionally, or alternatively, the models 422 may process the multi-dimensional model 416 to determine a path with the least amount of obstacles/traffic, such that the drones will not interfere with other warehouse operations. The action planning model may utilize the metrics 423 associated with air travel to determine instructions associated with drone navigation. Thus, the action planning system 420 may determine an optimized route for the one or more drones to follow in order to capture the necessary data.

The action implementation system 406 may implement one or more actions determined by the action planning system 420. In some implementations, the action implementation system 406 may be a separate system from the AIMS 404. In other implementations, the action implementation system 406 may be included as part of the AIMS 404 (e.g., such as part of the action planning system 420).

The action implementation system 406 may control a computing device/system to implement the determined action. For example, the action implementation system 406 may implement actions by outputting and transmitting instructions pertaining to the actions to respective computing devices/systems capable of executing the instructions. For example, the instructions may be transmitted to the autonomous drone 112. The instructions may instruct the autonomous drone 112 to capture additional data (e.g., autonomous drone sensor data 410) associated with the warehouse environment 100. Additionally, or alternatively, the instructions may be transmitted to a mobile computing device (e.g., mobile device 330). The instructions may instruct the mobile computing device to display information via a user interface of the mobile computing device. As such, a user of the mobile computing device (e.g., individual 110) may read and utilize the information presented via the user interface in order to complete a task which optimizes one or more aspects related to the warehouse environment 100.

The action implementation system 406 may configure instructions based on the end device that receives the instructions. For example, the action implementation system 406 may access a library or API that indicates how the instructions should be formatted to command a drone (e.g., to travel to a particular location within the warehouse environment 100). In another example, the action implementation system 406 may access a library or API that indicates how the instructions should be formatted to command a forklift (e.g., to travel to a particular location within the warehouse environment 100). In another example, the action implementation system 406 may access a library or API that indicates how the instructions should be formatted to command a mobile computing device (e.g., to capture sensor data).

FIG. 5 is a representation of an example multi-dimensional warehouse model, according to some implementations of the present disclosure. The multi-dimensional warehouse model 500 may be a digital warehouse model. The multi-dimensional model 500 may be provided as a two-dimensional model or a three-dimensional model. As such, the multi-dimensional warehouse model 500 may be provided as an exact, or near exact replica of the warehouse environment 100. For example, the multi-dimensional warehouse model 500 may include digital inventory models 502, digital storage rack models 504, digital forklift models 506, digital pallet models 508, and any other digital models that may be representative of objects within the warehouse environment 100.

As previously discussed, the multi-dimensional warehouse model 500 may be generated from sensor data acquired by one or more sensors. In some examples, the sensor data used to generate multi-dimensional warehouse model 500 may be images, such as pictures captured by a camera. Additionally, or alternatively, the camera may record videos while navigating the warehouse environment 100 and still images from the video may be used. As such, a plurality of images may be available such that a photogrammetry process may be used to generate a model of an area of warehouse environment 100. For instance, the plurality of images may be compared and software may be used to recognize and match one or more features within the plurality of images. By matching features within the plurality of images, the software may generate a point cloud based on the calculated positions of the objects within the plurality of images. The software may then utilize the point cloud to further create a mesh by connecting points within the point cloud. As such, geometries representative of the area of warehouse environment 100 may be generated. The software may further refine the geometries and add textures (e.g., overlay the still images) to transform the geometries into a visual representation of the area of warehouse environment 100 (e.g., generate digital inventory 502, digital storage racks 504, etc.). This photogrammetry process may be repeated for multiple areas within warehouse environment 100 such that a full model of warehouse environment 100 may be generated.

In other examples, the sensor data may be depth measurements, such as distances determined by ranging sensors (e.g., LiDAR sensors or time-of-flight (ToF) sensors). The ranging sensors may emit laser pulses and measure a time it takes for the emitted laser pulses to reflect off objects and return to the ranging sensor. The measured times may be used to determine distances from the ranging sensor to objects in the environment (e.g., warehouse environment 100) of the ranging sensor. The multi-dimensional model 500 may then be generated based on the determined distances.

As previously discussed, the multi-dimensional model 500 may be updated over time to account for any changes made to the warehouse environment 100. In some examples, the multi-dimensional model 500 may be made up of a plurality of sections. Each section may be a predetermined size and correspond to a section of warehouse environment 100. Each section may be individually generated and implemented when updating the multi-dimensional model 500. For example, the multi-dimensional model 500 may be updated section by section in a predetermined order. By updating the multi-dimensional model 500 in sections, the processing power required to generate updates to the multi-dimensional model may be less than the processing power needed to generate an entirely new multi-dimensional model 500. As such, an updated multi-dimensional model 500 may be generated sectionally over time, such that the AIMS (e.g., AIMS 404) may execute other processes concurrently.

Additionally or alternatively, an updated multi-dimensional model may be generated in full before the previous multi-dimensional model is replaced. In some examples, the updated multi-dimensional model is generated at a set time. For example, the set time may be a time at which fewer or no other processes are occurring. In other examples, the updated multi-dimensional model is generated following updated data representative of the full warehouse environment 100 being received by the AIMS. For example, the AIMS may determine that every portion of the warehouse environment 100 has since been measured by sensors and that the previously generated multi-dimensional model is not representative of the most current received sensor data. As such, an updated multi-dimensional model will be generated.

FIG. 6 depicts an example data structure, according to some implementations of the present disclosure. The example data structure 600 may be similar or the same as data structure 418. Data structure 600 may be provided as a table. The table may include a plurality of columns and rows, wherein N may be any number depending on the number of visual images captured by one or more sensors.

The data structure 600 may include, for example, a first table 601A. The first column may include visual data 604A. The visual data 604A may include an image captured by one or more sensors and sent to the data structure 600. Additionally, or alternatively, the visual data 604A may include a video captured by one or more sensors and sent to the data structure 600. The entirety of the video may be stored or a software program may break the video down into a plurality of still images to be sent to the data structure 600. In some examples, the images stored may be raw images captured and sent directly from the one or more sensors (e.g., not edited or manipulated in any way). The visual data 604A may be stored in the visual data column for later use by one or more machine learned models (e.g., models 422). The visual data 604A may be stored in any desired order, such as, but not limited to, in the order the visual data 604A was received, in the order the visual data 604A was captured, based on the location where the visual data 604A was captured, etc.

The second column may include a time stamp 606A. In some examples, the time stamp 606A may be provided in standard time (e.g., 12:00 AM-11:59 PM). In other examples, the time stamp 606A may be provided in “military time” (e.g., 0:00-23:59). In some examples, the time stamp 606A may indicate a time associated with each instance of visual data. For example, the time stamp 606A may indicate a time at which the visual data was captured by a sensor. Additionally, or alternatively, the time stamp 606A may indicate a time at which the visual data 604A was received by a computing system (e.g., AIMS computing system 208) and stored in the data structure 600. In other examples, the time stamp 606A may include multiple time values relating to each visual data 604A entry (e.g., including, but not limited to, the previous examples).

The third column may include a location stamp 608A. The location stamp 608A may indicate a location that the associated visual data 604A was captured (e.g., a coordinate within the multi-dimensional model indicating where the visual data 604A was captured). In some examples, the location stamp 608A may be provided as a predetermined naming format that describes an area of warehouse environment 100. In some examples, the warehouse environment 100 may identify storage racks by a first coordinate (e.g., a letter) and an area on the storage rack by a second coordinate (e.g., a number), such that the warehouse environment 100 resembles a grid. As such, a position in the warehouse environment 100 may be described using a coordinate set (e.g., F9). In other examples, the location stamp 608A may be provided as a GPS location (e.g., longitude and latitude values). As previously discussed, the sensor, or a device carrying the sensor that captures visual data 604A, may contain a GPS tracking device. As such, the current position of the GPS tracker when the visual data 604A is captured may also be captured and associated with the visual data entry.

The data structure 600 may include, for example, a second table 601B. The second table 601B may include information generated from raw visual data. In some examples, a computer vision model may analyze raw visual data captured by one or more sensors to determine objects within the visual data. For example, the computer vision model may identify a visual marker attached to one or more items of inventory on a pallet. The visual marker may include, for example, a bar code. The computer vision model may read the barcode in order to determine the item of inventory in the captured visual data. In some examples, the computer vision model may be capable of scanning the barcode and receiving an item classification. In other examples, the computer vision model may capture an image of the barcode and compare the image to a database of bar codes, wherein the matching barcode is representative of the item in the visual data. In other examples, the computer vision model may identify the item by visual properties of the item. For example, some items may not be stored in boxes and may have uncommon dimensions. The computer vision model may be capable of analyzing an image and capturing the dimensions of the item. The dimensions of the item may then be compared to a database to identify the item of inventory. As such, the computer vision model may determine the item of inventory and how much of the certain item is in the visual data. Thus, the data structure may not include raw data, and in contrast, may be filled with determined information about the raw data.

The first column may include a product identifier 604B. As previously disclosed, computer vision models may analyze visual data and determine an item of inventory (e.g., product), then store the product identifier 604B. In some examples, the product identifier 604B may be the name of the product, such as, but not limited to, the name of the product on a website, the name of the product in stores, the most well-known name of the product, etc. In other examples, the product identifier 604B may be a code or other combination of digits and letters used to identify the product (e.g., a part number). The product identifiers 604B may be stored in any desired order, such as, but not limited to, in the order the product identifiers 604B were determined from the visual data 604A, based on the location where the visual data containing the product was captured, in alphabetical order based on the product identifier 604B, etc.

The second column may include a time stamp 606B. In some examples, the time stamp 606B may be provided in standard time (e.g., 12:00 AM-11:59 PM). In other examples, the time stamp 606B may be provided in “military time” (e.g., 0:00-23:59). In some examples, the time stamp 606B may indicate a time associated with each product 604B. For example, the time stamp 606B may indicate a time at which the product 604B was captured. Additionally, or alternatively, the time stamp 606B may indicate a time at which the product 604B was determined by a computing system (e.g., AIMS computing system 208) and stored in the data structure 600. In other examples, the time stamp 606B may include multiple time values relating to each product 604B entry (e.g., including, but not limited to, the previous examples).

The third column may include a location stamp 608B. The location stamp 608B may indicate a location associated with product 604B. In some examples, the location stamp 608B may be provided as a predetermined naming format that describes an area of warehouse environment 100. In some examples, the warehouse environment 100 may identify storage racks by a first coordinate (e.g., a letter) and an area on the storage rack by a second coordinate (e.g., a number), such that the warehouse environment 100 resembles a grid. As such, a position in the warehouse environment 100 may be described using a coordinate set (e.g., F9). In other examples, the location stamp 608B may be provided as a GPS location (e.g., longitude and latitude values). As previously discussed, the sensor, or a device carrying the sensor, that captures visual data may contain a GPS tracking device. As such, the current position of the GPS tracker when the visual data is captured may also be captured and associated with the product identifier 604B entry.

The fourth column may include an amount entry 610. The amount entry 610 may indicate a captured amount of the particular product 604B. In some examples, the amount entry 610 may include a case count associated with each product 604B. As such, each amount entry 610 may indicate how many cases of each product 604B were determined from the sensor data. In other examples, the amount entry 610 may include a total item count. For example, multiple items of a particular product 604B may be packaged into a single case or box (e.g., each case stores 30 products). By determining a case count for the product 604B, a total item count may be determined by multiplying the case count by a known amount of product in each case.

In some examples, data structure entries may be individually recorded in the data structure 600. For example, each time visual data 604A is captured, an entry may be added to data structure 600. Thus, multiple amounts of the same type of product stored in different locations may each have a separate entry. In other examples, associated products may be consolidated into a single entry. For example, if visual data 604A captures multiple different pallets of the same product stored at different locations, a single entry may be consolidated and added to data structure 600. The single entry may include a consolidated amount (e.g., total amount determined from the multiple pallets). The single entry may include multiple location stamps to indicate that the product may be found at a plurality of locations.

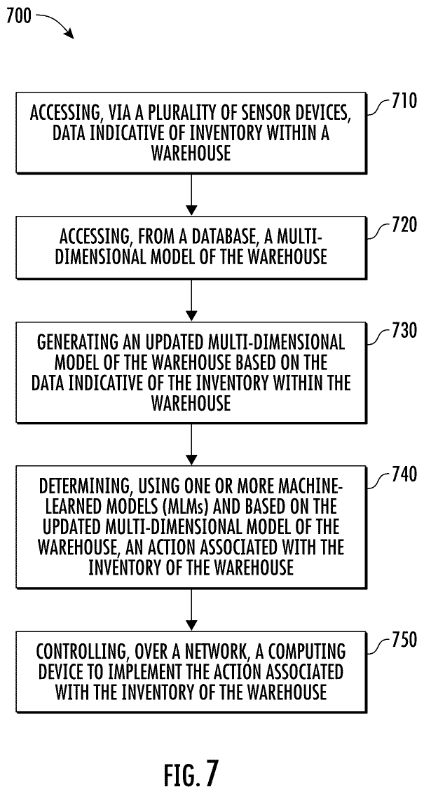

FIG. 7 depicts a flowchart of an example method, according to some implementations of the present disclosure. One or more portion(s) of the method 700 may be implemented by a computing system that includes one or more computing devices such as, for example, the computing systems described with reference to the other figures (e.g., a system of FIGS. 1-6). Each respective portion of the method 700 may be performed by any (or any combination) of one or more computing devices. Moreover, one or more portion(s) of the method 700 may be implemented on the hardware components of the device(s) described herein (e.g., as in FIGS. 1-6, etc.).

FIG. 7 depicts elements performed in a particular order for purposes of illustration and discussion. Those of ordinary skill in the art, using the disclosures provided herein, will understand that the elements of any of the methods discussed herein may be adapted, rearranged, expanded, omitted, combined, or modified in various ways without deviating from the scope of the present disclosure. FIG. 7 is described with reference to elements/terms described with respect to other systems and figures for exemplary illustrated purposes and is not meant to be limiting. One or more portions of method 700 may be performed additionally, or alternatively, by other systems.

At 710, the method 700 may include accessing data indicative of inventory within a warehouse (e.g., warehouse environment 100). The data may be accessed via a plurality of sensor devices. The plurality of sensor devices may include a drone, forklift, mobile device, etc. The mobile device may include a phone, tablet, laptop, wearable computing device (e.g., smartwatch), virtual reality (VR) device (e.g., VR headset), augmented reality (AR) device (e.g., AR headset), body camera, etc. The data may include pictures, videos, three-dimensional occupancy views, timestamps, barcode labels, case dimensions, case counts, inventory specifics, etc.

In some implementations, the sensor devices, or objects carrying the sensor devices, may be instructed to navigate the warehouse in order to capture data associated with the inventory. For example, the drone (e.g., autonomous drone 300) may be instructed to navigate to/within a portion of the warehouse such that a sensor device attached to the drone (e.g., camera 304) may capture data describing the inventory within said portion of the warehouse. Additionally, or alternatively, the sensor devices may periodically (e.g., on a schedule or when available) or continuously capture data while other tasks are being performed without being specifically instructed to capture any specific data. For example, a sensor device may be attached to a forklift (e.g., forklift 310). As the forklift navigates (e.g., autonomously or non-autonomously) the warehouse to complete tasks associated with storage and transportation of items, the sensor device (e.g., camera 322) may, for at least a portion of time, capture data indicative of inventory items within a field of view of the sensor device. Similarly, a sensor device (e.g., camera 334) may be attached to, or part of, a mobile device (e.g., mobile device 330). The mobile device may be carried by, or attached to, an individual within the warehouse environment (e.g., a worker, forklift driver, supervisor, etc.). As the individual navigates the warehouse to complete everyday tasks, the sensor device may capture data, for at least a portion of the time. The everyday tasks may or may not be associated with inventory data capture. Any of the above methods, individually or in combination, may be used to capture data indicative of the inventory. For example, all of the above implementations may be used concurrently.

At 720, the method 700 may include accessing a multi-dimensional model of the warehouse. The multi-dimensional model (e.g., multi-dimensional model 416) may be stored in a database (e.g., database 414) of an autonomous inventory management system (e.g., AIMS 404). The multi-dimensional model may be provided as a three-dimensional (3D) model. The multi-dimensional model may be a digital model, wherein a user may interact with the digital model. For example, the user may select and view certain areas of the multi-dimensional model, manipulate the multi-dimensional model, perform functions on the multi-dimensional model, etc.

The multi-dimensional model may be accessed in order to determine a status of the current multi-dimensional model. In one embodiment, the multi-dimensional model may be an outdated (e.g., not most recently captured) representation of the warehouse. The multi-dimensional model may be determined as outdated by determining that a threshold amount of time has passed since the multi-dimensional model was generated. Additionally, or alternatively, the multi-dimensional model may be identified as outdated by determining that data with a more recent time stamp than the multi-dimensional model has been received. As such, an updated multi-dimensional model may be generated to replace the outdated multi-dimensional model. In another embodiment, the multi-dimensional model may be an up-to-date representation of the warehouse. As such, the multi-dimensional model may be verified as accurate.

At 730, the method 700 may include generating an updated multi-dimensional model of the warehouse based on the data indicative of the inventory within the warehouse. The data may be analyzed to determine information associated with the data. For example, a type of inventory and amount of said inventory type may be determined. The determined information, alone or in combination with the raw collected data, may be utilized to generate the updated multi-dimensional model.

In some examples, the updated multi-dimensional model may be generated from the previous multi-dimensional model. For example, the multi-dimensional models may include objects not generated from captured data. The multi-dimensional models may include a predetermined warehouse layout with predetermined objects and parameters. The predetermined warehouse layout may not depict the actual warehouse environment. In contrast, the predetermined warehouse layout may arrange objects within the warehouse such that the objects may be easily tracked and viewed. For example, the predetermined warehouse layout may include an arbitrary storage area. The arbitrary storage area may include areas for digital inventory to be generated, wherein the digital inventory is indicative of the inventory within the warehouse and determined from the data. As such, the multi-dimensional warehouse more efficiently presents the inventory information, such that the inventory information is easier to perceive. For example, the actual warehouse may not be optimally arranged due to reasons that may not be controlled (e.g., available area, available landscape, warehouse size, available funding used to build the warehouse, etc.). By utilizing a predetermined warehouse layout, the inventory may be easier to track and make decisions about as compared to utilizing the actual layout of the warehouse. Furthermore, a predetermined warehouse layout may not need to be regenerated each time an updated multi-dimensional model is generated. In contrast, the predetermined warehouse layout may remain the same and only the updated inventory information may be generated. Such process may save computing power and improve generation efficiency.

In other examples, the updated multi-dimensional model may be generated entirely based on the received data. As such, the updated multi-dimensional model may more fully depict the warehouse environment. For example, the updated multi-dimensional model may include the exact layout of the warehouse. Furthermore, the updated multi-dimensional model may include the inventory as well as captured objects not directly associated with the inventory (e.g., forklifts, workers, pallets, trashcans, pallet jacks, wrappers, storage racks, etc.) and the position of such objects at the time the objects were captured. By generating the warehouse entirely based on captured data, the multi-dimensional model may be a more accurate depiction of the warehouse as compared to only generating inventory information.

The updated multi-dimensional model generation may include a level of generation that is between only generating the inventory and generating the entirety of the warehouse. For example, certain aspects of the captured data may be used to generate the updated multi-dimensional model, while other aspects may be generated based on a predetermined layout or kept from the previous version of the multi-dimensional model. The updated multi-dimensional model may replace the current multi-dimensional model and may be stored in the database.

At 740, the method 700 may include determining an action associated with the inventory of the warehouse. The action may be determined using one or more machine-learned models (MLMs). The action may be determined based on the updated multi-dimensional model of the warehouse.

The one or more MLMs may be trained to analyze the updated multi-dimensional model and determine an action based on the analysis. In some examples, the MLMs analyze the multi-dimensional model to generate metrics (e.g., metrics 423) associated with the warehouse and inventory. The metrics may include dimensions associated with the warehouse. The metrics may further include item counts associated with each item of inventory associated with the warehouse. Other examples of generated metrics may include inventory accuracy, available storage space, pallet capacity, inventory order information, inventory shipment information, inventory arrival information, etc. By determining metrics, the visual data associated with the multi-dimensional model may be transformed into more specific numerical data associated with certain aspects of the warehouse and inventory. The metrics may be further analyzed to determine any anomalous values or optimization opportunities. For example, the metrics may portray that the warehouse storage capabilities are near full capacity, that pallets of like inventory are stored in multiple different locations, etc. The metrics and the updated multi-dimensional model may be utilized to determine an action associated with the inventory of the warehouse.

The action may be determined based on a metric satisfying a predetermined condition (e.g., crossing a predetermined threshold or triggering a predetermined condition). For example, if a generated metric is determined to satisfy the predetermined condition, an action may be determined which may cause the metric to not satisfy the predetermined condition. Thus, the determined action may optimize some aspect of the inventory, or a function related to the inventory.

In some examples, the action may include a routing action. The routing action may include a newly generated route for retrieving or locating one or more items of inventory for an order. By generating an optimized route, time and energy spent locating and retrieving inventory items may be decreased.

Additionally or alternatively, the action may include a storage action. The storage action may indicate a location to store an item of inventory. Inventory shipments may arrive at a certain location of the warehouse such as a loading bay. The inventory may need to quickly be stored in a location other than the loading bay in order to not interrupt other warehouse operations. By providing an available location to store the inventory, time and resources may be saved, while allowing the warehouse to operate efficiently.

Additionally or alternatively, the action may include a consolidation action. The consolidation action may indicate two locations currently storing one or more types of items of inventory. Storing separate amounts of the same item of inventory in different locations may be inefficient and lead to decreased storage capacity. For example, a first amount of the item stored at a first location of the two locations and a second amount of the item stored at a second location of the two locations may be combinable to be stored together at the first location or the second location. As such, consolidating the separate amounts may optimize storage capacities.

Additionally or alternatively, the action may include a drone routing action. The drone routing action may include a route for a drone to travel. By optimizing the drone route via metrics and MLMs, data representative of the warehouse and inventory may be more efficiently captured. Such improvement may result in increased production and allow warehouse operations to be completed more efficiently.

At 750, the method 700 may include controlling a computing device to implement the action associated with the inventory of the warehouse. The computing device may be controlled over a network. The computing device may be controlled by transmitting instructions to the computing device. The computing device may process the instructions to determine and operate its corresponding system to act accordingly in a physical or electrical manner.

The determined action may be associated with a specific device. In some examples, the instructions may be transmitted to a drone. The instructions may instruct the drone to capture additional data. For example, the multi-dimensional model may be determined as outdated. As such, an action to update the multi-dimensional model may be determined. The action may include instructing one or more drones to navigate the warehouse in order to capture data indicative of the warehouse. The one or more drones may receive a determined route to navigate and instructions to autonomously navigate the determined route. The data captured during navigation of the determined route may be used to generate an updated multi-dimensional model.

Additionally or alternatively, the instructions may be transmitted to a mobile computing device. The instructions may instruct the mobile computing device to display information. The information may be displayed via a user interface of the mobile computing device. For example, the mobile computing device may display a determined action for an individual to manually complete. The determined action may be provided as a task list. The task list may include one or more tasks to be completed. The one or more tasks may optimize aspects of the warehouse, such as, but not limited to, repositioning inventory, manually scanning a barcode that was missed earlier, etc. For example, metrics may determine that a certain inventory product is selling faster than others. As such, an action may be determined to store this inventory product closer to the loading bay in order to avoid unnecessary transportation distances. A task to begin storing the inventory product at a location closer to the loading bay may be displayed via the mobile computing device. The task may include an optimized route from the current location of the inventory to the new location. As another example, an order for a plurality of items may be received. As such, the mobile device may display the items of inventory that need to be picked, the locations of the items (e.g., based on the multi-dimensional model), and the most optimal path for the worker to navigate to pick the items (e.g., as determined from metrics associated with the warehouse and inventory). The mobile computing device may further display a dashboard associated with the AIMS. For example, the dashboard may include one or more sections. The sections may include a section that displays multiple metrics determined from the visual data, a section that allows a user to view the multi-dimensional model, and a section containing an input field. The input field may include a search bar. For example, a user may search for one or more features of the AIMS. The search feature may incorporate a large language model (LLM). As such, a user may ask questions (e.g., via chat, text, natural voice, etc.) related to the warehouse and receive answers associated with their questions.

The answers may include information about the subject of the question, as well as any instructions that may be helpful to resolve a situation. For example, a user may ask the AIMS where the closest location is to find a certain amount of a particular inventory. The AIMS may respond (e.g., through text, voice, visuals, etc.) with some or all the locations that the particular inventory may be found, as well as the most preferred location to pick the particular inventory from, due to other metrics (e.g., this location is more optimal because the next order is in a location close to this location, first-in-first-out rules dictate that this location's supply should be picked before others, etc.).

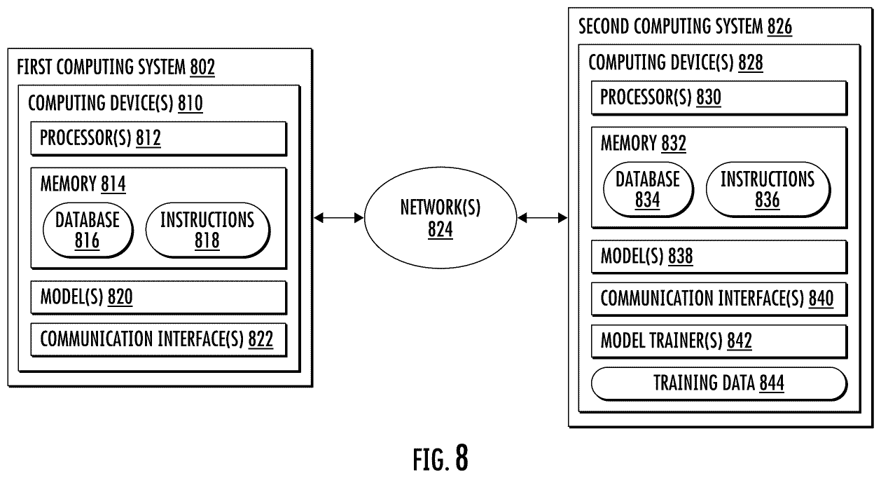

FIG. 8 depicts an example computing ecosystem, according to some implementations of the present disclosure. The system 800 includes a first computing system 802 and a second computing system 826 that are communicatively coupled over a network 824.

The first computing system 802 includes one or more computing devices 810. The one or more computing devices 810 include one or more processors 812 and a memory 814. The one or more processors 812 can be any suitable processor device (e.g., a processor core, a microprocessor, an ASIC, a GPU, an FPGA, a controller, a microcontroller, etc.) and can be one processor or a plurality of processors that are operatively connected. The memory 814 can include one or more non-transitory computer-readable storage media, such as RAM, ROM, EEPROM, EPROM, flash memory devices, magnetic disks, etc., and combinations thereof. The memory 814 can store data 816 and instructions 818 which are executed by the processor 812 to cause the first computing system 802 to perform operations. The one or more computing devices 810 can include one or more communication interfaces 822.

In some implementations, the first computing system 802 can store or include one or more machine-learning models 820 and/or one or more non-machine-learning algorithms. The machine-learning models 820 can be or can otherwise include various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks. Some example machine-learned models can leverage an attention mechanism such as self-attention. For example, some example machine-learned models can include multi-headed self-attention models (e.g., transformer models).

In some implementations, the machine-learning models 820 can be received from the second computing system 826 over network 824, stored in the first computing system memory 814, and then used or otherwise implemented by the one or more processors 812. In some implementations, the first computing system 802 can implement multiple parallel instances of machine-learning models 820.

Additionally, or alternatively, one or more machine-learning models 838 can be included in or otherwise stored and implemented by the second computing system 826 that communicates with the first computing system 802. The second computing system 826 includes one or more computing devices 828. The one or more computing devices 828 include one or more processors 830 and a memory 832. The one or more processors 830 can be any suitable processor device (e.g., a processor core, a microprocessor, an ASIC, a GPU, an FPGA, a controller, a microcontroller, etc.) and can be one processor or a plurality of processors that are operatively connected. The memory 832 can include one or more non-transitory computer-readable storage media, such as RAM, ROM, EEPROM, EPROM, flash memory devices, magnetic disks, etc., and combinations thereof. The memory 832 can store a database 834 and instructions 836 which are executed by the processor 830 to cause the second computing system 826 to perform operations. The one or more computing devices 828 can include one or more communication interfaces 840.

In some implementations, the second computing system 826 includes or is otherwise implemented by one or more server computing devices. In instances in which the second computing system 826 includes plural server computing devices, such server computing devices can operate according to sequential computing architectures, parallel computing architectures, or some combination thereof.

As described above, the second computing system 826 can store or otherwise include one or more machine-learning models 838. For example, the models 838 can be or can otherwise include various machine-learned models. Example machine-learned models include neural networks or other multi-layer non-linear models. Example neural networks include feed forward neural networks, deep neural networks, recurrent neural networks, and convolutional neural networks. Some example machine-learned models can leverage an attention mechanism such as self-attention. For example, some example machine-learned models can include multi-headed self-attention models (e.g., transformer models).

The first computing system 802 and/or the second computing system 826 can train the models 820 and/or 838 via interaction with a model trainer 842. The model trainer 842 can be configured to train the machine-learned models 820 and/or 838 stored at the first computing system 802 and/or the second computing system 826 using various training or learning techniques, such as, for example, backwards propagation of errors. For example, a loss function can be backpropagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over a number of training iterations.

In some implementations, performing backwards propagation of errors can include performing truncated backpropagation through time. The model trainer 842 can perform a number of generalization techniques (e.g., weight decays, dropouts, etc.) to improve the generalization capability of the models being trained. In particular, the model trainer 842 can train the machine-learning models 820 and/or 838 based on a set of training data 844. The training data 844 can include, for example, previously recorded radar signals labeled for one or more tasks. As an example, the radar signals can be labeled to indicate whether the signals correspond to the presence of one or more objects, a speed of the objects, an object type associated with the object(s), etc.

The model trainer 842 includes computer logic utilized to provide desired functionality. The model trainer 842 can be implemented in hardware, firmware, and/or software controlling a general purpose processor. For example, in some implementations, the model trainer 842 includes program files stored on a storage device, loaded into a memory and executed by one or more processors. In other implementations, the model trainer 842 includes one or more sets of computer-executable instructions that are stored in a tangible computer-readable storage medium such as RAM, hard disk, or optical or magnetic media.

The network 824 can be one or more of any type of communications network, such as a local area network (e.g., intranet), wide area network (e.g., Internet), or some combination thereof and can include any number of wired or wireless links. In general, communication over the network 824 can be carried through one or more of any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

Computing tasks discussed herein as being performed at one computing device can instead be performed at a device/system that is remote from the computing device, or vice versa. Such configurations can be implemented without deviating from the scope of the present disclosure. The use of computer-based systems allows for a great variety of possible configurations, combinations, and divisions of tasks and functionality between and among components. Computer-implemented operations can be performed on a single component or across multiple components. Computer-implemented tasks or operations can be performed sequentially or in parallel. Data and instructions can be stored in a single memory device or across multiple memory devices.

Aspects of the disclosure have been described in terms of illustrative implementations thereof. Numerous other implementations, modifications, or variations within the scope and spirit of the appended claims can occur to persons of ordinary skill in the art from a review of this disclosure. Any and all features in the following claims can be combined or rearranged in any way possible. Accordingly, the scope of the present disclosure is by way of example rather than by way of limitation, and the subject disclosure does not preclude inclusion of such modifications, variations or additions to the present subject matter as would be readily apparent to one of ordinary skill in the art. Moreover, terms are described herein using lists of example elements joined by conjunctions such as “and,” “or,” “but,” etc. It should be understood that such conjunctions are provided for explanatory purposes only. Lists joined by a particular conjunction such as “or,” for example, can refer to “at least one of” or “any combination of” example elements listed therein, with “or” being understood as “and/or” unless otherwise indicated. Also, terms such as “based on” should be understood as “based at least in part on.”

Those of ordinary skill in the art, using the disclosures provided herein, will understand that the elements of any of the claims, operations, or processes discussed herein can be adapted, rearranged, expanded, omitted, combined, or modified in various ways without deviating from the scope of the present disclosure. Some of the claims are described with a letter reference to a claim element for exemplary illustrated purposes and is not meant to be limiting. The letter references do not imply a particular order of operations. For instance, letter identifiers such as (a), (b), (c), . . . , (i), (ii), (iii), . . . , etc. can be used to illustrate operations. Such identifiers are provided for the ease of the reader and do not denote a particular order of steps or operations. An operation illustrated by a list identifier of (a), (i), etc. can be performed before, after, or in parallel with another operation illustrated by a list identifier of (b), (ii), etc.

The term “can” should be understood as referring to a possibility of a feature in various implementations and not as prescribing an ability that is necessarily present in every implementation. For example, the phrase “X can perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

The term “may” should be understood as referring to a possibility of a feature in various implementations and not as prescribing an ability that is necessarily present in every implementation. For example, the phrase “X may perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

What is claimed is:

1. A computer-implemented method comprising:
accessing, via a plurality of sensor devices, data indicative of inventory within a warehouse;
accessing, from a database, a multi-dimensional model of the warehouse;
generating an updated multi-dimensional model of the warehouse based on the data indicative of the inventory within the warehouse;
determining, using one or more machine-learned models (MLMs) and based on the updated multi-dimensional model of the warehouse, an action associated with the inventory of the warehouse; and
controlling, over a network, a computing device to implement the action associated with the inventory of the warehouse.

2. The method of claim 1, wherein the plurality of sensor devices comprise at least one of (i) drones, (ii) forklifts with sensors, or (iii) mobile devices with cameras.

3. The method of claim 1, wherein the multi-dimensional model is a three-dimensional (3D) model and the updated multi-dimensional model is an updated 3D model.

4. The method of claim 1, wherein determining, using one or more MLMs and based on the updated multi-dimensional model of the warehouse, an action associated with the inventory of the warehouse comprises:
generating, via one or more MLMs, based on the database, metrics associated with the warehouse and the inventory of the warehouse; and
determining the action based on the metrics.

5. The method of claim 4, wherein the metrics comprise:
dimensions associated with the warehouse; and
item counts associated with each item of the inventory of the warehouse.

6. The method of claim 1, wherein the action associated with the inventory of the warehouse comprises a routing action, the routing action comprising a newly generated route for retrieving or locating one or more items of inventory for an order.

7. The method of claim 1, wherein the action associated with the inventory of the warehouse comprises a storage action, the storage action indicating a location to store an item of the inventory.

8. The method of claim 1, wherein the action associated with the inventory of the warehouse comprises a consolidation action, the consolidation action indicating two locations currently storing one or more types of items of the inventory.

9. The method of claim 8, wherein a first amount of the item at a first location of the two locations and a second amount of the item at a second location of the two locations are combinable to be stored together at the first location or the second location.

10. The method of claim 1, wherein the action associated with the inventory of the warehouse comprises a drone routing action, the drone routing action comprising a route for a drone to travel.

11. The method of claim 1, wherein controlling the computing device comprises transmitting instructions to the computing device.

12. The method of claim 11, wherein (i) the instructions are transmitted to a drone, the instructions instructing the drone to capture additional data or (ii) the instructions are transmitted to a mobile computing device, the instructions instructing the mobile computing device to display information via a user interface of the mobile computing device.

13. The method of claim 1, wherein the updated multi-dimensional model is stored in the database.

14. An autonomous inventory management system comprising:
one or more processors; and
one or more tangible, non-transitory, computer-readable media that store instructions that are executable by the one or more processors to perform operations comprising:
accessing, via a plurality of sensor devices, data indicative of inventory within a warehouse;
accessing, from a database, a multi-dimensional model of the warehouse;
generating an updated multi-dimensional model of the warehouse based on the data indicative of the inventory within the warehouse;
determining, using one or more machine-learned models and based on the updated multi-dimensional model of the warehouse, an action associated with the inventory of the warehouse; and
transmitting, over a network, instructions to a computing device to implement the action associated with the inventory of the warehouse.

15. The autonomous inventory management system of claim 14, wherein the plurality of sensor devices comprise at least one of (i) drones, (ii) forklifts with sensors, or (iii) mobile devices with cameras.

16. The autonomous inventory management system of claim 14, wherein the multi-dimensional model is a three-dimensional (3D) model and the updated multi-dimensional model is an updated 3D model.

17. The autonomous inventory management system of claim 14, wherein determining, using one or more machine-learned models and based on the updated multi-dimensional model of the warehouse, an action associated with the inventory of the warehouse comprises:
generating, via machine learning models, based on the database, metrics associated with the warehouse and the inventory within the warehouse; and
determining the action based on the metrics.

18. The autonomous inventory management system of claim 17, wherein the metrics comprise:
dimensions associated with the warehouse; and
item counts associated with each item of the inventory of the warehouse.

19. The autonomous inventory management system of claim 14, wherein the action associated with the inventory of the warehouse comprises a routing action, the routing action comprising a newly generated route for retrieving one or more items of inventory for an order.

20. One or more tangible, non-transitory, computer readable media storing instructions that are executable by one or more processors to perform operations comprising:
accessing, via a plurality of sensor devices, data indicative of inventory within a warehouse;
accessing, from a database, a multi-dimensional model of the warehouse;
generating an updated multi-dimensional model of the warehouse based on the data indicative of the inventory within the warehouse;
determining, using one or more machine-learned models and based on the updated multi-dimensional model of the warehouse, an action associated with the inventory of the warehouse; and
transmitting, over a network, instructions to a computing device to implement the action associated with the inventory of the warehouse.
